(19) United States
(12) Patent Application Publication
(10) Pub. No.: US 2015/0213440 A1
(43) Pub. Date: Jul. 30, 2015

(54) Pre-Paid Virtual Card and Method for Its Creation and Its Utilization

(71) Applicant: 2 PAY S.R.L., Marcon (IT)

(72) Inventors: Diego Occari, Padova (IT); Daniele Bernardi, Marcon (IT)

(73) Assignee: 2 PAY S.R.L., Marcon (IT)

(21) Appl. No.: 14/422,347

(22) PCT Filed: Sep. 4, 2013
(86) PCT No.: PCT/IB2013/001903

§ 371 Date: Feb. 18, 2015

(30) Foreign Application Priority Data
Sep. 6, 2012 (IT) PD2012A000257

(51) Int. Cl. G06Q 20/34; G06Q 20/40

(52) U.S. Cl. CPC G06Q 20/351; G06Q 20/4012

(57) ABSTRACT

A pre-paid virtual card has an identifier number that includes the telephone subscription number of a smartphone, by which the pre-paid virtual card is created at the moment in which an application (APP), developed to create the pre-paid virtual card, is downloaded onto the smartphone, to automatically associate with its identifier the telephone subscription number, and to establish at least a first connection with an Electronic Money Institution (EMI), with which at least the e-mail address of the holder of the subscription, a password for subsequent access, and a PIN security code for future payments instructions must be registered.

The present invention relates to a pre-paid virtual card and to a method for its creation and its utilization.

Virtual prepaid cards exist consisting of electronic money instruments, used to make payments without materially transferring money. These provide for the person concerned to stipulate with an authorized Electronic Money Institution (EMI) or with a Bank, a contract according to which, as a result of transfers made in determined manners to a certain account held at the Electronic Money Institution or at a Bank Institution connected thereto, the person concerned has an availability of money, with which to make on-line purchases, obviously within limits set by appropriate regulations.

Traditional virtual prepaid cards are characterised by a sixteen digit PAN code, which has to be entered by the user each time the card is used to make an on-line purchase, and by an IBAN code, to be used to top-up the card.

It is also known to use virtual prepaid cards as payment cards to top-up physical prepaid cards. However there is no way in which payments can be made from one virtual prepaid card to another.

Finally, it is known to use cell phones in payment systems, including to transfer money by debiting a credit card of the settlor.

However there is no way in which the cell phone can be used to create and to use virtual prepaid cards as electronic money instruments.

An object of the invention is to create a virtual prepaid card usable as an electronic money instrument both to make payments and to make money transfers.

Another object of the invention is to create a virtual prepaid card of very simple use.

Another object of the invention is to create a pre-paid virtual card which substantially reduces entering errors by the user while at the same time facilitating control operations by the operator.

These and other objects which will be apparent from the ensuing description are attained according to the invention by a pre-paid virtual card presenting the characteristics indicated in claim 1.

The invention also comprises a method for creating a pre-paid virtual card as indicated in claim 2.

A preferred embodiment of the invention is further clarified hereinafter by way of non-limiting example.

In greater detail, the pre-paid virtual card according to the invention consists of an electronic money instrument characterised, as are all electronic money instruments, by an identifier which, in the case of a traditional pre-paid virtual card, is assigned by the service operator, whereas according to the present invention, it consists of the telephone subscription number of the cell phone used for creating the pre-paid virtual card and for its use.

For its creation, the user uses a smartphone, to download from the internet an APP application developed precisely for this purpose.

When the APP has been downloaded, it opens a panel in which the user can indicate the language and the currency chosen for the use of the pre-paid virtual card.

Having made these choices, the APP proposes to the user the option of operating in anonymous form (and in this case with limits in the maximum amount usable within a predetermined time period and in the amount usable for a single operation, limits dictated by anti money-laundering regulations valid at any given time in each individual country), or in registered form (and in this case without said limits or with different limits).

In any event, and independently of the manner in which the user intends to operate, the APP creates a pre-paid virtual card and associates therewith the phone number of the smartphone, into which the APP has been downloaded. It then proposes a panel, into which the user has to insert at least an E-mail address, an APP access password and a six-digit PIN security code to set the future payment arrangements, obviously within the limits established by anti money-laundering regulations.

If the user wishes to operate in registered mode, the APP presents in the smartphone a panel in which the user has to insert, in addition to the E-mail address, the password and the PIN code, also his/her personal data, tax code, a telephone number and possible V.A.T. number.

If a user who initially opted to operate in anonymous mode later decides to operate in registered mode, he/she can add to the APP that data which had initially not been supplied.

All the data which the APP has to acquire to create the pre-paid virtual card can be entered by the user at the moment in which the APP is downloaded, or, if at that stage the APP was limited to creating the pre-paid virtual card and to associate with the identifier of this the number of the cell phone into which the APP was downloaded, then at the moment in which the APP is opened for its initial use.

Independently of this, all the data regarding that user and which have been acquired by the APP have to be registered with an Electronic Money Institution (EMI) which operates the network of the pre-paid virtual card according to the invention.

Registration can be done automatically by the APP at the moment in which it was downloaded and had received the user significant data, or the data can be transmitted by the user to the EMI by the APP at the moment of its initial use, or can be transmitted directly by the user to the EMI, to which the APP has connected it at the moment of its initial use.

The manner with which the user stipulates with the EMI the contract which governs the relationship between the two in relation to the pre-paid virtual card is traditional and requires no further description.

The EMI evidently has its own computer system able to govern all relationships with users who are holders of pre-paid virtual cards.

After the pre-paid virtual card has been created, and the user data have been registered by the computer system of the EMI, the use of the APP is extremely simple, in the sense that once the APP has been opened, this proposes a screen with different options corresponding to the operations which the user has to carry out.

Funds Transfer

If the user wishes to transfer funds to another pre-paid virtual card pertaining to the same network, he/she chooses the option “SEND”, which proposes a panel in which the user has to enter the identifier of the beneficiary, i.e. the telephone subscription number thereof, the amount to be transferred, possible message or reason, and any request for forwarding the settlor identifier data to the beneficiary.

Once the procedure is activated, the APP forwards the request to transfer funds to the EMI, which first verifies in its computer system the existence of the beneficiary identifier, and the presence in the pre-paid virtual card of sufficient funds to carry out the transaction.

If this check is positive, the EMI transmits to the settlor, through the APP, the main data of the beneficiary, if known, to enable the settlor to check the correctness of the data entered and the instructions given, and asks the settlor to confirm the transaction by entering the PIN code, or to cancel the operation if an error is found.

When the user has confirmed the operation, the computer system of the EMI verifies the correctness of the settlor PIN code and whether the number of the cell phone which give the order, is the same as that onto which the APP was downloaded at the moment of creating the pre-paid virtual card, and as the EMI code, which uniquely identifies the cell phone which gave the order, providing in fact a “hard authentication” of three levels of security. If the check is positive, the EMI performs the operation and informs the settlor and the beneficiary of its successful execution, while updating in real time the availability of the respective pre-paid virtual cards.

Transferring Funds to an Actual Current Account

With the pre-paid virtual card according to the invention funds can also be transferred to an actual current account. In this case the user chooses from the initial screen proposed by the APP at the time of its opening, the option “ORDER TO PAY”, which is a sub-option of the “SEND” option. In this case the APP proposes a different panel, requiring entry of the data required to perform the operation, and in particular the IBAN number of the beneficiary, the name of beneficiary, the amount and the reason.

In this case the APP forwards the request to the EMI, which carries out a preliminary check on the correctness of the IBAN code of the beneficiary and of sufficient availability in the settlor pre-paid virtual card to carry out the transaction. After performing these checks the EMI sends the data to the bank of the beneficiary to obtain a verification of the correctness of the IBAN code inserted by the settlor and the amount to be paid, then on the basis of these data retransmitted to the settor for his/her verification, requests confirmation of the operation.

This confirmation is given by the settlor by entering the PIN code.

On obtaining this confirmation the EMI updates the availability on the prepaid virtual card of the settlor, taking into account not only the amount transferred but also any commission, and also performs the usual operations connected with the transfer of funds to an actual current account.

Transferring Funds to a Beneficiary not the Holder of an Actual Current Account

With the pre-paid virtual card according to the invention, money can also be transferred to a beneficiary not belonging to the EMI network, and hence not a holder of a pre-paid virtual card.

In this case the procedure requires the user to insert into the APP the telephone number of the beneficiary.

In this case, on receiving the instructions from the settlor via the APP, the EMI sends an SMS to the cell phone indicated by the settlor, inviting the holder of this cell phone to download the APP and to register it to have the money credited.

Request for Payment

Another option for the holder of the pre-paid virtual card according to the invention is to request a payment to another person pertaining to the EMI network, and hence a holder of another pre-paid virtual.

In this case, from the initial screen which appears on the user's cell phone at the time of opening the APP, the user chooses the option “REQUEST” and enters into the panel proposed by the APP the cell phone number which identifies the user, to which the requested payment is aimed, the amount requested and the possible reason.

The request is checked by the EMI in the form already seen, and is then forwarded to the cell phone of the recipient who is able to give the payment authorization by inserting his/her own PIN code.

Checking the Account

The same APP also provides on the initial screen next to the two items “SEND” (which also includes within it the function “PAYMENT”) and “REQUESTS”, the item “ACCOUNT”, which allows the holder of the pre-paid virtual card to display his/her account on his/her cell phone, including the latest transactions, to verify the correctness of the operations carried out.

It should be noted that the invention, in addition to providing for communications between each user and the EMI, to take place via the APP, also enables these to also take place directly between the user and the EMI, except evidently for the initial contact to create the pre-paid virtual card, which always takes place between the user and the APP.

Finally, if the transactions take place between pre-paid virtual card holders who have chosen to work with a different currency, the computer system of the EMI instantly converts the amounts at the latest availability currency rate, crediting the beneficiary with the already converted amount and applying the commissions for the currency transaction.

In addition to these specific functions in the use of the pre-paid virtual card, further options can be provided, not strictly related to it, but still useful for carrying out with the cell phone other operations related to the use of actual credit cards held by the same user.

For this purpose, as an alternative to the use of the pre-paid virtual card, the user can also use actual credit cards, even without having them materially available. These cards must be pre-registered with the APP by inserting for each of them the relative data (name of issuer, sixteen digit identifier number, name and surname of holder, expiry date, three digit security code, and any PIN code). Following this registration the credit card or credit cards may appear as options, as an alternative to the pre-paid virtual card, on the initial screen that appears on opening the APP, and allows the user to use them without having them physically available.

Essentially, the present invention differs significantly from all known pre-paid virtual cards, in that instead of having a card identifier attributed by the operator of the electronic money network, it has a different identifier, consisting of the same number as the telephone subscription number used to create the pre-paid virtual card and used when using the card. This brings a very large number of benefits for both the user and the service provider.

As regards the user, the fact that the pre-paid virtual card identifier is the same as the telephone subscription number is advantageous in that:
a phone number is easier to remember than any other identifier; consequently a pre-paid virtual card that has as its identifier number the number of the cell phone permits an undeniable simplification in payments;
any payment can be made by simply asking the beneficiary for his/her cell phone number, which he/she will have to hand without having to do any research; moreover if the beneficiary is already the holder of a pre-paid virtual card, he/she will immediately receive the amount transmitted, otherwise a pre-paid virtual card can be requested by a practically immediate operation, without any delay,
the normal phonebook with which any cell phone is provided, allows any user to immediately have available the telephone numbers of those with which he/she has most frequent contact and to which money can be transferred without the need to search for, remember, or ask clients, friends or suppliers for difficult to remember codes,
the creation of a closed circuit by means of a pre-paid virtual card system allows money to be transferred with immediate effect, completely avoiding the inter-bank network and the POS network, with significant savings in bank charges, particularly for transactions between parties in different countries,
the facility to top-up the pre-paid virtual card by debiting a credit card enables virtually any person to receive payments by credit card debiting, in addition to those to whom this facility was reserved in the past.

With regard to the service provider, this can also derive important advantages from the invention, in that:
the widespread availability of cell phones enables a large number of persons to posses a pre-paid virtual card,
public accessibility to cell phone lists, in compliance with applicable privacy provisions, makes mass distribution of the payment service extremely simple, including by SMS,
the uniqueness of user telephone numbers and of holder identification provides an important tool in controlling both the authenticity of transactions and their absolute traceability,
the fact that the pre-paid virtual card identifier is the same as the telephone subscription number considerably simplifies the control procedures and drastically reduces errors.

The invention claimed is:

1. A pre-paid virtual card
an identifier number consisting of a telephone subscription number of a smartphone,
wherein the pre-paid virtual card is created at a moment in which an application (APP), developed to create said pre-paid virtual card, is downloaded onto said smartphone, said APP automatically associating said identifier number with said telephone subscription number, and establishing at least a first connection with an Electronic Money Institution (EMI), with which at least an e-mail address of a holder of said subscription, a password for subsequent access, and a PIN security code for future payment instructions must be registered.

2. A method of providing a pre-paid virtual card comprising:
downloading from the internet onto a smartphone an application (APP), which at a moment in which said APP is downloaded creates a pre-paid virtual card and automatically associates with an identifier thereof a telephone subscription number of said smartphone; and
registering with an Electronic Money Institution (EMI), which is to operate said pre-paid virtual card, at least said telephone subscription number, an e-mail address of a holder of said subscription, a password for subsequent access, and a PIN security code for future payment instructions.

3. The method as claimed in claim 2, further comprising the step, after said application (APP) has created the pre-paid virtual card and has assigned the telephone subscription number as the identifier thereof, connecting to said Electronic Money Institution (EMI) to register therewith data relative to a holder of the pre-paid virtual card, said password and said PIN code.

4. The method as claimed in claim 2, wherein data relative to a holder of the pre-paid virtual card, said password and said PIN code is registered with said Electronic Money Institution (EMI) at a moment of initial use of said pre-paid virtual card.

5. The method as claimed in claim 2, wherein, on opening said application (APP), an internet connection is established with said Electronic Money Institution (EMI), communications between a user and the Electronic Money Institution taking place via the application (APP).

6. The method as claimed in claim 2, further comprising the step of establishing direct communications between a user and the Electronic Money Institution (EMI).

7. The method as claimed in claim 2, wherein, each time said pre-paid virtual card is used, several options are proposed on a smartphone screen, selected from the group consisting of funds transfer, request for payment, and control of an account of said pre-paid virtual card.

8. The method as claimed in claim 2, wherein, if a user wishes to transfer funds to another pre-paid virtual card operatively coupled to a same network, the following steps are performed:
though said application (APP), having a settlor enter an identifier of a beneficiary, the identifier of the beneficiary comprising a telephone subscription number thereof and an amount to be transferred;
causing said application (APP) to forward then a request to transfer funds to the Electronic Money Institution (EMI), which first verifies in its computer system whether a beneficiary identifier exists, and a presence in the pre-paid virtual card of sufficient funds to carry out a predetermined transaction;
if the verification is positive, causing the Electronic Money Institution (EMI) to transmits to the settlor, through said application (APP), main data of the beneficiary, if known, to enable the settlor to check correctness of entered data and of provided instructions, and asking the settlor to confirm the transaction by entering the PIN code, or to cancel the transaction if an error is found;
when the settlor has confirmed the transaction, causing a computer system of the Electronic Money Institution (EMI) to verify correctness of the settlor's PIN code, correspondence of the number of the cell phone which ordered the transaction with the number of the cell phone onto which said application (APP) was downloaded at the moment of creating the pre-paid virtual card, and also correspondence of an International Mobile Equipment Identity (IMEI) code, which uniquely identifies the cell phone which gave the order; and
if the check is positive, causing the Electronic Money Institution (EMI) to perform the transaction and inform the settlor and the beneficiary of successful execution of the transaction, while updating in real time availability of the respective pre-paid virtual cards.

9. The method as claimed in claim 2, wherein if a user wishes to transfer funds to an actual current account, the following steps are performed:
having a settlor enter, through said application (APP), data required to perform a transfer, including IBAN code of a beneficiary, name of the beneficiary, amount and reason for the transfer;
causing said application (APP) to forward a request to the Electronic Money Institution (EMI), which carries out a preliminary check on correctness of the IBAN code of the beneficiary and of sufficient availability in the settlor pre-paid virtual card to carry out the transfer;
causing the Electronic Money Institution (EMI), after performing the preliminary check, to send the data to a bank of the beneficiary to obtain a verification of correctness of the IBAN code inserted by the settlor and the amount to be paid, and then, based on the data retransmitted to the settor for the settlor's verification, causing the Electronic Money Institution (EMI) to request confirmation of operation;,
having the settlor then give said confirmation by entering the security PIN code; and
on obtaining said confirmation, causing the Electronic Money Institution (EMI) to update availability on the prepaid virtual card of the settlor, taking into account the amount transferred and any commissions, and to perform usual operations connected with the transfer of funds to an actual current account.

10. The method as claimed in claim 2, wherein if a user wishes to transfer funds to a beneficiary who does not hold a pre-paid virtual card, the following steps are performed:
the user inserts into said application (APP) a telephone number of a beneficiary; and
on receiving instructions from a settlor via said application (APP), causing the Electronic Money Institution (EMI) to send a SMS to a cell phone indicated by the settlor, inviting a holder of the cell phone to download said application (APP) and to register said application (APP) to have the funds credited.

11. The method as claimed claim 2, wherein if a user wishes to request a payment to a recipient belonging to the Electronic Money Institution (EMI) network, the recipient being a holder of another pre-paid virtual card, the following steps are performed:
through said application (APP), having the user enter a cell phone number which identifies the recipient, a requested amount, and a reason for the payment;
causing the Electronic Money Institution (EMI) to check the request, the Electronic Money Institution (EMI) first verifying in its computer system existence of a recipient identifier, and presence in the pre-paid virtual card of sufficient funds to carry out the payment; and
forwarding the request to the cell phone of the recipient, who provides payment authorization by inserting the recipient's PIN code.

12. The method as claimed in claim 2, wherein said application (APP) allows the holder of the pre-paid virtual card to display the holder's account on the holder's cell phone, including latest transactions, thereby verifying correctness of operations carried out.

13. The method as claimed in claim 2, wherein if transactions take place between pre-paid virtual card holders who have chosen to work with a different currency, a computer system of the Electronic Money Institution (EMI) instantly converts amounts at a latest availability currency rate, crediting a beneficiary with a converted amount and applying a commissions for the currency transaction.
